(19) United States
(12) Patent Application Publication
(10) Pub. No.: US 2023/0415721 A1
(43) Pub. Date: Dec. 28, 2023

(54) METHOD FOR OPERATING AN ELECTROPNEUMATIC PARKING BRAKE SYSTEM, AND ELECTROPNEUMATIC PARKING BRAKE SYSTEM

(71) Applicant: ZF CV Systems Global GmbH, Bern (CH)

(72) Inventors: Robert Otremba, Ronnenberg (DE); Andreas Peters, Obernkirchen (DE); Alexander Wassmann, Suthfeld (DE)

(21) Appl. No.: 18/464,055

(22) Filed: Sep. 8, 2023

Related U.S. Application Data
(63) Continuation of application No. PCT/EP2022/055074, filed on Mar. 1, 2022.

(30) Foreign Application Priority Data
Mar. 10, 2021 (DE) 10 2021 105 755.8

(51) Int. Cl. B60T 13/38; B60T 15/02; B60T 8/17; B60T 17/22; B60T 13/68

(52) U.S. Cl. CPC B60T 13/385; B60T 15/027; B60T 2270/88; B60T 17/22; B60T 13/683; B60T 8/17

(57) ABSTRACT

A method is for operating a parking brake system with a spring-loaded brake and a control module in a motor vehicle or trailer. The control module is connected to a parking brake circuit. The method includes supplying the parking brake circuit with reservoir pressure. The method further includes applying spring-loaded accumulator holding pressure to the spring-loaded brake cylinders in order to have the spring-loaded brake assume a release position, wherein the spring-loaded accumulator holding pressure is less than the reservoir pressure in the parking brake circuit.

### CROSS-REFERENCE TO RELATED APPLICATIONS

This application is a continuation application of international patent application PCT/EP2022/055074, filed Mar. 1, 2022, designating the United States and claiming priority from German application 10 2021 105 755.8, filed Mar. 10, 2021, and the entire content of both applications is incorporated herein by reference.

### TECHNICAL FIELD

The disclosure relates to a method for operating a parking brake system with a spring-loaded brake and a control module in a motor vehicle or trailer. The disclosure also relates to an electropneumatic parking brake system, a computer program product, an electropneumatic control module, and a vehicle with a parking brake system.

In particular the subject is a method for operating a parking brake system with a spring-loaded brake and a control module, in a motor vehicle or trailer, wherein the control module is connected to a parking brake circuit, the parking brake circuit is supplied with reservoir pressure, and a spring-loaded accumulator holding pressure is applied to the spring-loaded brake cylinders in order to assume a release position of the spring-loaded brake.

### BACKGROUND

In vehicles, in particular commercial vehicles, with an electropneumatic brake system, electropneumatic valves can be activated by an electronic control unit in order to control brake pressures, the valves transmitting a brake pressure pneumatically to brake cylinders of the brake system depending on a requested vehicle target deceleration.

An electropneumatic brake system for a vehicle includes a service brake system and a parking brake system. The service brake system has an electronic control unit for activating electropneumatic valve assemblies in order thus to apply brake pressure to the brake cylinders of a service brake.

The parking brake system has a spring-loaded brake. A force for actuating this brake is applied by spring-loaded accumulators which are arranged in spring-loaded brake cylinders. Air is supplied to the spring-loaded brake cylinders only in order to release the spring-loaded brake. When air is exhausted from the spring-loaded brake cylinders, the spring-loaded brake is active and brakes the vehicle.

An electropneumatic brake system with a spring-loaded brake is disclosed, for example, in US 2020/0079341.

An electric switch, via which a corresponding signal can be output to an electronic control device of the parking brake system, can be provided in a driver's cab of the vehicle in order to actuate the spring-loaded brake. The electronic control device then switches one or more electropneumatic valve assemblies such that air is either supplied to or exhausted from the spring-loaded brake cylinders. A system of this type is also referred to as an electropneumatic hand brake.

The electropneumatic hand brake also contains an electropneumatic control module with a pneumatic input for connection to a brake circuit of the electropneumatic brake system and a pneumatic output for connection to the spring-loaded brake cylinders. A reservoir pressure of the connected brake circuit is usually present at the input. An output pressure at the output is the pressure which is applied to the spring-loaded brake cylinders. If the output pressure equals zero, air is exhausted from the spring-loaded brake cylinders. If the output pressure is the same as the reservoir pressure, air is supplied to the spring-loaded brake cylinders and the spring-loaded brake is released. The output pressure which exists when the spring-loaded brake is released is referred to here as the spring-loaded accumulator holding pressure.

The spring-loaded brake is not only actuated by the electric switch in the driver's cab but can also be triggered by other electronic or pneumatic systems present in the vehicle, for example in the case of a decrease in the reservoir pressure in one of the brake circuits of the vehicle, in the case of a line being torn off between the towing vehicle and the trailer, in the case of the trailer becoming uncoupled from the towing vehicle, or for other reasons. In individual cases, particularly quick actuation of the spring-loaded brake can be necessary or helpful.

Depending on the configuration and the intended use, the parking brake system can also wholly or partially have a purely pneumatic configuration. Accordingly, a pneumatic or electropneumatic control module can be provided.

The reservoir pressure in the parking brake system is specified by legal regulations and/or technical standards. The same is true for a spring-loaded accumulator release pressure. This is the lowest pressure at which a spring-loaded accumulator does not transmit any more force to a pressure rod in the spring-loaded brake, that is, at which there is no longer any braking effect caused by the spring-loaded brake cylinders. As soon as the pressure falls below the spring-loaded accumulator release pressure, a braking effect occurs. The spring-loaded accumulator release pressure can also be fixed by the manufacturer of the braking system as part of regulatory requirements. The spring-loaded accumulator release pressure is significantly less than the reservoir pressure so that it is ensured that the spring-loaded brake can be released completely.

### SUMMARY

It is an object of the disclosure to provide a method via which the spring-loaded brake can be transferred from a completely released state into a state with a braking effect particularly quickly.

In order to achieve the object, a method according to the disclosure, for example, is for operating a parking brake system with a spring-loaded brake and a control module in a motor vehicle or trailer, wherein the control module is connected to a parking brake circuit. The method includes: supplying the parking brake circuit with reservoir pressure; and, applying spring-loaded accumulator holding pressure to the spring-loaded brake cylinders in order to have the spring-loaded brake assume a release position, wherein the spring-loaded accumulator holding pressure is less than the reservoir pressure in the parking brake circuit. In particular, it is provided that a spring-loaded accumulator holding pressure is applied to the spring-loaded brake cylinders which is less than the reservoir pressure in the parking brake circuit. Of course, the spring-loaded accumulator holding pressure is still above the spring-loaded accumulator release pressure. However, the gap from the spring-loaded accumulator release pressure is less than was usually the case beforehand. As a result, the mass of air to be moved when air is exhausted from the spring-loaded brake cylinders is also less than beforehand. The spring-loaded brake can be engaged correspondingly more quickly. The period of time before the spring-loaded brake acts is shortened by methods according to the disclosure.

The spring-loaded accumulator holding pressure does not necessarily have to be the highest pressure at the output of the preferably electropneumatic control module. For example, a higher pressure can be controlled for a short period of time in order to quickly release the spring-loaded accumulators. The spring-loaded accumulator holding pressure is then set after the release of the spring-loaded brake.

According to a further concept of the disclosure, the spring-loaded accumulator holding pressure can be 1 to 5 bar below the reservoir pressure. The spring-loaded accumulator holding pressure can advantageously be set correspondingly. In Europe, the reservoir pressure in the brake circuit is preferably 8.5 bar. Based on this or another pressure, the spring-loaded accumulator holding pressure is set to be lower by 1 to 5 bar.

The spring-loaded accumulator holding pressure can advantageously be 1.5 to 3 bar below the reservoir pressure or be set correspondingly. In Europe, the spring-loaded accumulator release pressure is usually 5 to 5.5 bar. A spring-loaded accumulator holding pressure of 1.5 to 3 bar below the reservoir pressure ensures, on the one hand, a sufficient gap from the spring-loaded accumulator release pressure and, on the other hand, a significantly higher speed when engaging the spring-loaded brakes.

According to a further concept of the disclosure, the spring-loaded accumulator holding pressure can be above a spring-loaded accumulator release pressure by at least a safety margin, preferably at least 1 to 2 bar above it. The desired safety margin is used to calculate and set the spring-loaded accumulator holding pressure and should take into account practically possible deviations or fluctuations of the spring-loaded accumulator release pressure. The spring-loaded accumulator release pressure is dependent on the properties of the spring-loaded brake and can either be determined by trial and error or exists as information provided by the manufacturer. The properties of the spring-loaded brake can also change because of wear and corrosion.

According to a further concept of the disclosure, the spring-loaded accumulator holding pressure can be determined by a valve assembly which acts in a pressure-limiting, pressure-reducing, or pressure-regulating fashion. This is preferably a purely pneumatic/mechanical solution which is active even in the case of a power failure or faults in the control module and which is applied in particular in trailers.

According to a further concept of the disclosure, the spring-loaded accumulator holding pressure can be set by computer program-controlled regulation of a valve assembly. With program-controlled regulation, precise and reproducible setting is possible, in particular in an electropneumatic brake system. A change can also be made subsequently by adapting the program control.

Various methods according to the disclosure can advantageously be used to operate a parking brake system both in towing vehicles or motor vehicles and in trailers.

It is a further object of the disclosure to provide a parking brake system for a motor vehicle or a trailer and in particular for performing the method according to the disclosure. A parking brake system can include: a spring-loaded brake; a control module for a motor vehicle or trailer; the control module being connected to a brake circuit, wherein the brake circuit is supplied with a reservoir pressure; the spring-loaded brake including spring-loaded brake cylinders configured to have a spring-loaded accumulator holding pressure applied thereto in order to assume a release position of the spring-loaded brake; and, a setting device for setting the spring-loaded accumulator holding pressure to a value which is less than the reservoir pressure in the brake circuit. The parking brake system advantageously includes a spring-loaded brake and a control module, wherein the latter is connected to a brake circuit which supplies a reservoir pressure, and a spring-loaded accumulator holding pressure can be applied to spring-loaded brake cylinders for assuming a release position of the spring-loaded brake. According to the disclosure, means are provided for setting the spring-loaded accumulator holding pressure to a value which is less than the reservoir pressure in the brake circuit. As a result, the parking brake system can supply air to the spring-loaded brake much more quickly than before. It is preferably an electropneumatic parking brake system and in particular an electropneumatic control module.

According to a further concept of the disclosure, the parking brake system can have a valve assembly with an input pressure and an output pressure, wherein the valve assembly supplies the spring-loaded accumulator holding pressure as the output pressure. The input pressure is preferably the reservoir pressure of the relevant brake circuit. The valve assembly is here the means for determining or setting the spring-loaded accumulator holding pressure. The valve assembly advantageously is or contains at least one pressure regulating valve with or without an air-exhaust function, or alternatively a pressure limiting valve or a pressure reducing valve. The purpose in each case is to supply the desired spring-loaded accumulator holding pressure.

According to a further concept of the disclosure, the parking brake system can have an electronic control device via which the output pressure of the valve assembly can be regulated. The electronic device and the valve assembly interact to regulate the output pressure.

According to a further concept of the disclosure, the parking brake system can have a pressure sensor for sensing the output pressure and for transmission to the electronic control device. A rapid regulating circuit can be implemented via the pressure sensor.

According to a further concept of the disclosure, the valve assembly can have a pneumatic relay valve and an electropneumatic proportional valve, wherein the output pressure is present at an output of the valve assembly, the relay valve receives control pressure from the proportional valve, and the proportional valve is activated by the electronic control device in order to set the output pressure. Effective regulation of the output pressure is thus possible with simple equipment. The proportional valve can also be implemented by a synchronized switching valve.

According to a further concept of the disclosure, the valve assembly and the electronic control device can be constituent parts of the control module. A high degree of integration of the required components is achieved as a result.

According to a further concept of the disclosure, the valve assembly can contain a pressure limiting valve. The latter enables a defined output pressure to be set without any electronic components. This is a particularly robust solution, preferably for purely pneumatic parking brake systems.

According to a further concept of the disclosure, the valve assembly can have a non-return valve connected in parallel to the pressure limiting valve. Adaptation of a higher output pressure which may occur to a lower input pressure is possible as a result.

According to a further concept of the disclosure, the valve assembly can be integrated into a control module. The presence of an additional component outside the in particular electropneumatic control module is avoided as a result.

According to a further concept of the disclosure, the valve assembly can be integrated into a pneumatic control line between a parking valve assembly and a control module. This arrangement enables simple retrofitting into an existing parking brake system.

According to a further concept of the disclosure, valve assemblies can be integrated into brake cylinder assemblies. One valve assembly with a pressure limiting valve is provided per brake cylinder. The brake cylinders are preferably combination brake cylinders with service brake cylinders and spring-loaded brake cylinders. The complexity is greater than in the case of a central valve assembly but does afford a high degree of redundancy.

According to a further concept of the disclosure, valve assemblies can be integrated into pneumatic working lines between a control module and spring-loaded brake cylinders. The spring-loaded brake cylinders can be constituent parts of combination brake cylinders. Simple retrofitting with a high degree of redundancy is possible with this configuration.

According to a further concept of the disclosure, the control module is an axle modulator. This measure improves the integration and avoids the need for additional structural space outside the parts of the parking brake system which are present anyway. The axle modulator is advantageously at the same time a constituent part of a service brake systems and also controls a service brake.

It is a further object of the disclosure to provide a computer program product including commands which, carried out on an electronic control device of a control module in a parking brake system, carry out a method according to the disclosure. It includes in particular commands which, carried out on an electronic control device of a control module in a parking brake system, carry out the method according to the disclosure.

Also a subject of the disclosure is an electropneumatic control module configured for use in a parking brake system as described above, with an electronic control device and for use in a parking brake system according to the disclosure.

Lastly, it is a further object of the disclosure to provide vehicle with a parking brake system according to the disclosure.

All aspects of the disclosure are valid for or can be applied to towing vehicles and trailers as long as they have an electropneumatic or pneumatic parking brake system.

### BRIEF DESCRIPTION OF DRAWINGS

The invention will now be described with reference to the drawings wherein:

FIG. 1 shows a schematic illustration of an electropneumatic brake system in a towing vehicle;

FIG. 2 shows an electropneumatic control module of an electropneumatic parking brake system inside the electropneumatic brake system;

FIG. 3 shows a schematic illustration of a valve assembly with a pressure limiting valve and a non-return valve;

FIG. 4 shows a highly simplified illustration of a parking brake system in a trailer and with a modulator with an integrated valve assembly according to FIG. 3;

FIG. 5 shows an embodiment which is similar to FIG. 4 but with a valve assembly integrated into a control line between a parking valve and the modulator;

FIG. 6 shows an embodiment which is similar to FIG. 4 but with a valve assembly integrated into a parking valve;

FIG. 7 shows an embodiment which is similar to FIG. 4 but with valve assemblies integrated into combination brake cylinders;

FIG. 8 shows an embodiment which is similar to FIG. 4 but with valve assemblies integrated into working lines between the modulator and spring-loaded brake cylinders; and,

FIG. 9 shows a qualitative illustration of time-dependent pressure gradients when air is exhausted from spring-loaded brake cylinders.

### DETAILED DESCRIPTION

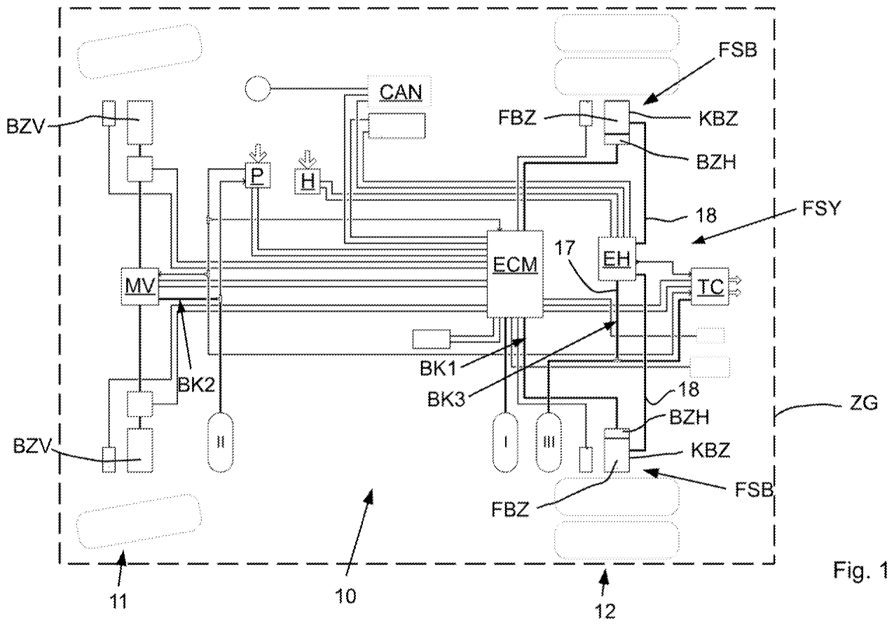

Illustrated in simplified form in FIG. 1 is an electropneumatic brake system 10 for a towing vehicle ZG with a front axle 11 and a rear axle 12. The basic structure of the brake system 10 is known and is disclosed in a similar form in US 2020/0079341.

Only the constituent parts which are relevant for understanding the disclosure are taken into account below. The brake system 10 here has three pneumatic brake circuits BK1, BK2, and BK3, each with a reservoir I, II, III. Compressors as compressed-air sources are not shown, and neither is a multi-circuit protection valve which may be present.

An axle modulator MV for the front axle 11 is provided in the brake circuit BK2. Front-axle service brake cylinders BZV of the front axle 11 are connected to the axle modulator MV.

An axle modulator, not illustrated in detail, for the rear axle 12 is combined with a central controller, likewise not shown in detail, to form a central unit ECM. The latter also controls the axle modulator MV for the front axle 11.

Connected to the central unit ECM are combination brake cylinders KBZ into which rear-axle service brake cylinders BZH and spring-loaded brake cylinders FSZ of the rear axle 12 are integrated. In order to pneumatically charge the rear-axle service brake cylinders BZH, the central unit ECM is connected to the brake circuit BK1 or is part thereof.

In order to supply air to the front-axle service brake cylinders BZV and rear-axle service brake cylinders BZH, the driver can actuate a brake encoder P (brake pedal). A corresponding signal of the brake encoder P passes to the central unit ECM. The latter activates the integrated axle modulator for the rear axle 12 and the front axle modulator MV.

The spring-loaded brake cylinders FSZ are a constituent part of a spring-loaded brake FSB inside a parking brake system FSY which is a subsystem of the electropneumatic brake system 10 and is provided with an electropneumatic control module EH. The control module EH is connected to the brake circuit BK3 and, when the spring-loaded brake FSB is released, emits an output pressure to supply air to the spring-loaded brake cylinders FBZ. In order to exhaust air from the spring-loaded brake cylinders FBZ and hence to actuate the spring-loaded brake FSB, an electric switch H, connected to the control module EH, is provided which, like the brake encoder P, can be operated by the driver.

Also connected to the electropneumatic control module EH is a trailer control module TC which is fed from the brake circuit BK3 but has no significance in this figure.

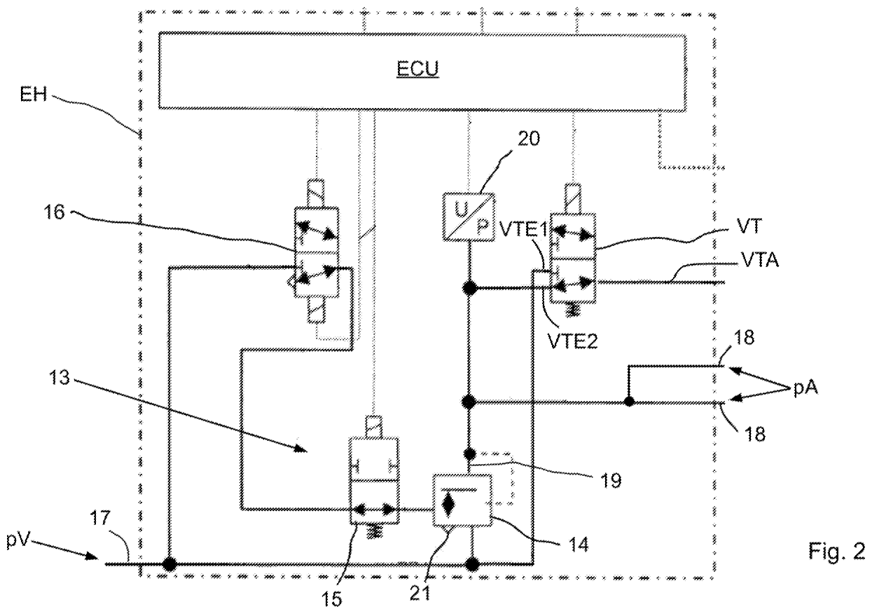

According to FIG. 2, in particular an electronic control device ECU and a valve assembly 13 are provided in the electropneumatic control module EH, wherein the valve assembly 13 is controlled by the control device ECU.

The electropneumatic brake system 10 is connected to a CAN bus of the vehicle ZG (see CAN in FIG. 1) or to another bus system which is typical for vehicles. The central unit ECM, the electropneumatic control module EH, and further electronic control units (not shown) of the vehicle can communicate with one another via the CAN bus and, for example, also transmit commands to actuate the spring-loaded brakes FSB to the electropneumatic control module EH. The electronic control device ECU in the control module EH can moreover have software which, under defined boundary conditions and/or with the input of defined signals, actuates or releases the spring-loaded brake FSB and exhausts air from or supplies it to the spring-loaded brake cylinders FBZ.

A possible structure of the electropneumatic control module EH is illustrated in FIG. 2. The main constituent parts of the valve assembly 13 are a relay valve 14 and an electropneumatic proportional valve 15. Arranged upstream from the proportional valve 15 is a bistable switching valve 16 via which the spring-loaded brake FSB is activated or deactivated. To do this, the switching valve 16 connects the proportional valve 15 to an input 17 of the control module EH or blocks this connection. In the position according to FIG. 2, the connection is blocked and the spring-loaded brake FSB is exhausted of air, that is, activated.

A reservoir pressure pV from the brake circuit BK3 is present at the input 17 of the control module EH. Output pressure pA for the spring-loaded brake cylinders FBZ is supplied at the outputs 18 of the control module EH. The relay valve 14 is connected to the input 17 and, via its valve output 19, to the outputs 20 and receives control pressure from the proportional valve 15.

The proportional valve 15 is here a 2/2-way valve which is switched through when no current is applied and closed when current is applied. A specific control pressure for the relay valve 14, and hence also a specific output pressure pA at the outputs 18 for supplying air to the spring-loaded brake cylinders FBZ can be set by modulating the proportional valve 15. The relay valve 14 thus forms, together with the proportional valve 15, a pressure regulating valve for the output pressure pA.

Connected to the outputs 18 and to the relay valve 14 is a pressure sensor 20, the signals of which are received and processed by the electronic control device ECU. A valve output VTA of a switching valve VT which is monostable in this case is connected to the trailer control module TC. Reservoir pressure pV is applied to a first valve input VTE1, while a second valve input VTE2 is connected to the valve output 19. It is consequently possible to maintain the valve output VTA and the trailer control module TC at reservoir pressure pV, while pressure regulation takes place for the outputs 18 via the relay valve 14. This advantageously prevents the pressure regulation affecting the pressure at an output (not shown) of the trailer control module TC.

The electronic control device ECU controls the output pressure pA present at the outputs 18 by actuating the valves 15, 16 by taking into account the signals of the pressure sensor 20. In order to release the spring-loaded brake FSB or supply air to the spring-loaded brake cylinders FBZ, the switching valve 16 is switched into a passage position (not shown) and modulates the proportional valve 15. The objective is a spring-loaded accumulator holding pressure pH as an output pressure pA at the outputs 18 which is less than the reservoir pressure pV at the input 17 and greater than a spring-loaded accumulator release pressure pL. The spring-loaded accumulator holding pressure pH is preferably 1 to 2 bar more than the spring-loaded release pressure pL and/or 1 to 3 bar less than the reservoir pressure pV.

Exhausting the air from the spring-loaded brake cylinders FBZ in order to actuate the spring-loaded brake FSB takes place in this case via an exhaust vent 21 at the relay valve 14 or an exhaust vent connected thereto. Starting from the relatively low spring-loaded accumulator holding pressure pH, the spring-loaded brake FSB can be exhausted of air much more quickly than in the case of an output pressure pA which corresponds to the reservoir pressure pV in the brake circuit BK3.

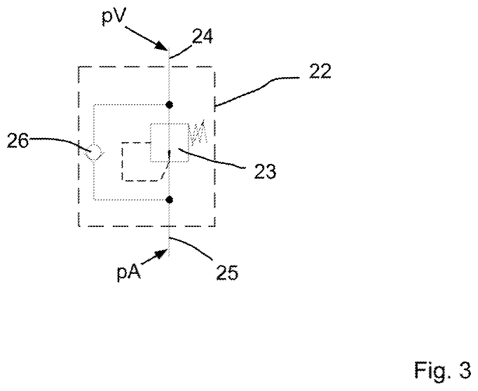

FIG. 3 shows a further valve assembly 22 for reducing the output pressure pA, in this case as a purely pneumatic/mechanical solution. The main constituent part of the valve assembly 22 is a pressure limiting valve 23 with an input 24 and an output 25. A non-return valve 26 is connected in parallel to the pressure limiting valve 23, that is, is also connected to the input 24 and the output 25.

The pressure limiting valve 23 is set and/or selected such that the desired output pressure pA and not the higher reservoir pressure pV is present at the output 25. The non-return valve 26 equalizes the pressure at the output 25 if the pressure at the input 24 falls.

The valve assembly 22 can preferably be used in a parking brake system FSY with a purely pneumatically controlled spring-loaded brake FSB. Use in an electropneumatic parking brake system FSY is, however, also possible.

Particular advantages for use in a trailer consist in the faster activation of the spring-loaded brake FSB, also as an emergency brake, and a reduction in the risk of the trailer unintentionally rolling away when uncoupled because the transfer of the braking effect of the service brake to the spring-loaded brake FSB takes place more quickly.

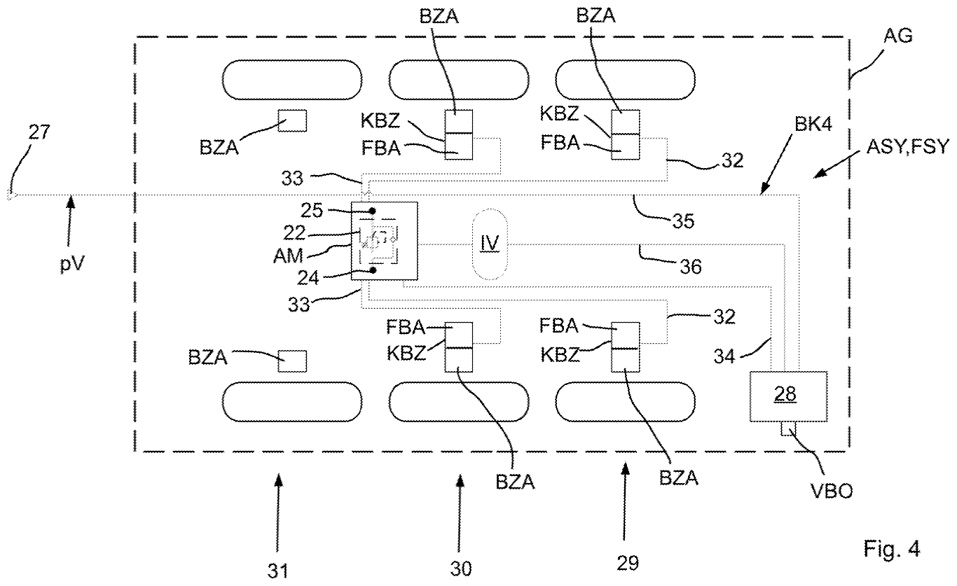

The embodiment in FIG. 4 relates to a trailer brake system ASY in a trailer AG, for example a semitrailer. Constituent parts of the trailer brake system ASY are a reservoir connection 27, a parking valve 28, also referred to as a parking release valve, a reservoir IV, a modulator AM, combination brake cylinders KBZ at two axles 29, 30, while a further axle 31 has only trailer service brake cylinders BZA. The combination brake cylinders KBZ are, in the same way as in the embodiment in FIG. 1, divided into trailer service brake cylinders BZA and trailer spring-loaded brake cylinders FBA.

A constituent part of the trailer brake system ASY is also in this case an electropneumatic parking brake system FSY which includes the trailer spring-loaded brake cylinders FBA. For the sake of simplification, only those lines which are important in connection with the spring-loaded brake system FSY are indicated in FIG. 4. The feeding and distribution of control pressure, similar to the reservoir connection 27, is also not illustrated. The parking brake system FSY can also be purely pneumatic.

The modulator AM regulates all the functions of the trailer brake system ASY, including the parking brake system FSY for the trailer AG and contains all the valve assemblies and control devices required for it. In the embodiment in FIG. 4, the valve assembly 22 is integrated into the modulator AM, that is, is a constituent part of the modulator AM. The reservoir pressure pV fed via the parking valve 28 is present at the input 24. The output 25 is connected to lines 32, 33 leading to the trailer spring-loaded brake cylinders FBA. A reservoir line 35 to the parking valve 28 leads from the reservoir connection 27. A further reservoir line 36 runs from the parking valve 28 to the reservoir IV and from there to the modulator AM. Alternatively, the modulator AM can be switched between the reservoir IV and the parking valve 28.

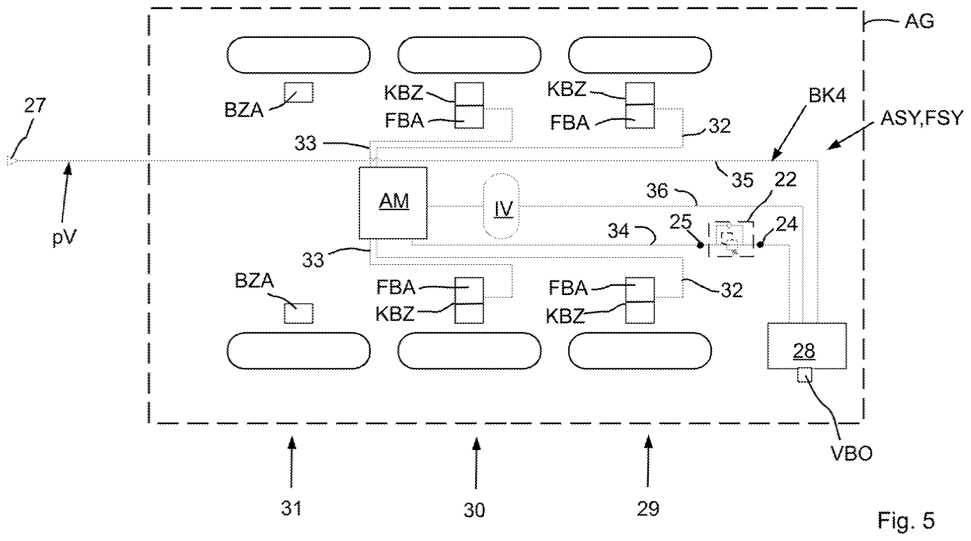

In the embodiment in FIG. 5, the valve assembly 22 is switched into a control line 34 from the parking valve 28 to the modulator AM. The input 24 faces the parking valve 28, while the output 25 faces the module AM. The valve assembly 22 can be retrofitted simply in this way.

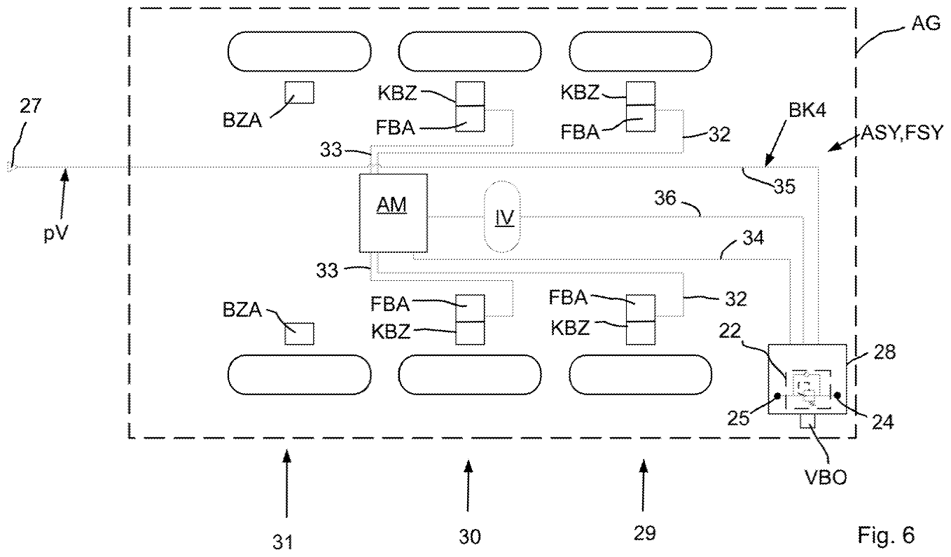

In the embodiment in FIG. 6, the valve assembly 22 is integrated into the parking valve 28, or is a part thereof. The interconnection of the input 24 and the output 25 is not illustrated. The output 25 is preferably connected to the control line 34. The input 24 is connected, inside the module AM, to a line (not shown) carrying reservoir pressure pV, to a line (not shown) connected to the reservoir IV, or to an exhaust opening (not shown). Which connection actually exists depends on the position of a manual actuating member VBO at the parking valve 28 and requires only a small additional degree of complexity inside the parking valve 28.

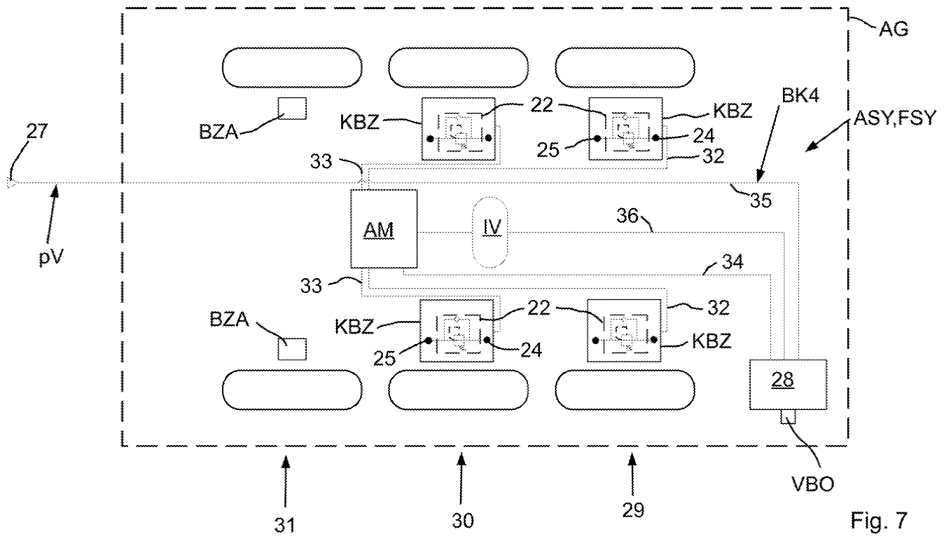

In the embodiment in FIG. 7, a valve assembly 22 is integrated into each combination brake cylinder KBZ. The inputs 24 can be connected to the lines 32, 33, while the outputs 25 are connected to the trailer spring-loaded brake cylinders FBA. The latter are not indicated in FIG. 7 for the sake of simplification but can be seen, for example, in FIG. 4. According to FIG. 7, the valve assemblies 22 are integrated into all the combination brake cylinders KBZ which are present. It is also possible to select them for or limit them to individual axles 29, 30 or wheels.

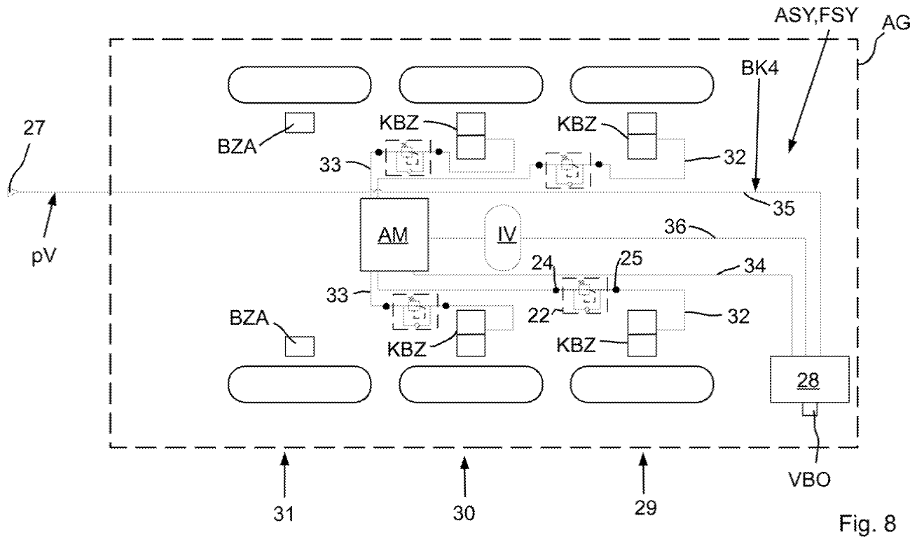

In the embodiment in FIG. 8, valve assemblies 22 are arranged in each of the lines 32, 33 between the modulator AM and the combination brake cylinders KBZ. The inputs 24 are here connected to the modulator AM and the outputs 25 to the trailer spring-loaded brake cylinders FBA inside the combination brake cylinders KBZ. This solution is also particularly well suited to retrofitting.

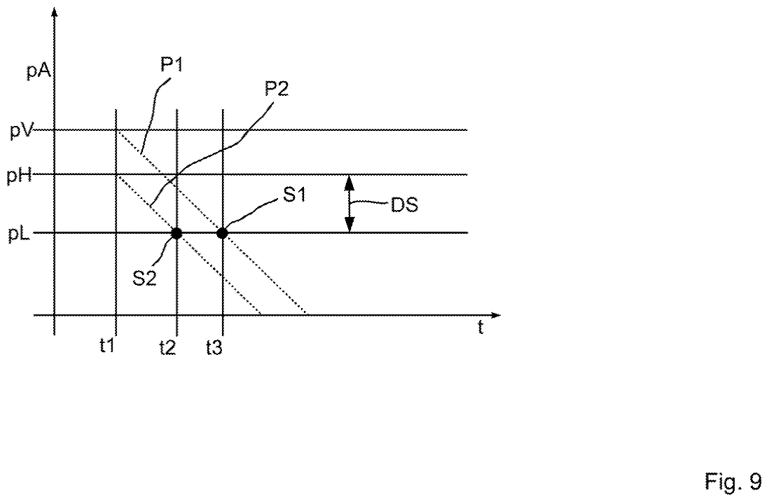

An essential advantage of the disclosure can be seen in FIG. 9. The gradient over time t of the output pressure pA can be seen. In the prior art, reservoir pressure pV is applied to the spring-loaded brake cylinders FBZ and trailer spring-loaded brake cylinders FBA which are supplied with air. According to the disclosure, the valve assemblies 13, 22 have an output pressure pA equal to the spring-loaded accumulator holding pressure pH. The spring-loaded accumulator holding pressure pH is less than the reservoir pressure pV and has a safety margin DS above the spring-loaded accumulator release pressure pL. Two different cases with their pressure gradient lines P1, P2 are illustrated.

Starting from the reservoir pressure pV in the first case and starting from the spring-loaded accumulator holding pressure pH in the second case, the possible gradient over time according to the dotted pressure gradient lines P1 and P2 results when the spring-loaded brake cylinders FBZ and trailer spring-loaded brake cylinders FBA are exhausted of air. Of interest are the points of intersection S1, S2 of the pressure gradient lines P1 and P2 with the spring-loaded accumulator release pressure pL. While the pressure gradient line P1 reaches the spring-loaded accumulator release pressure pL at the point of intersection S1 only at the point in time t3, the point of intersection S2 is above the much earlier point in time t2. A spring-loaded accumulator release time t2−t1 resulting in connection with the disclosure is correspondingly much less than the previously possible spring-loaded accumulator release time t3−t1.

The safety margin DS mentioned is to be selected such that dispersion of the spring-loaded accumulator release pressure pL and subsequent fluctuations due to wear and corrosion are taken into account such that the spring-loaded accumulator holding pressure pH never reaches the spring-loaded accumulator release pressure pL or falls below it.

The illustration in FIG. 9 is an idealized and purely qualitative one which serves only to explain the shortened period of time until the spring-loaded accumulator release pressure pL is reached.

All the embodiments illustrated here relate to use both in a tractor/motor vehicle and in a trailer, in particular a semitrailer, or can be transferred thereto.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

10 electropneumatic brake system
11 front axle
12 rear axle
13 valve assembly
14 relay valve
15 proportional valve
16 switching valve
17 input
18 outputs
19 valve output
20 pressure sensor
21 exhaust vent
22 valve assembly
23 pressure limiting valve
24 input
25 output
26 non-return valve
27 reservoir connection
28 parking valve
29 axle
30 axle
31 axle
32 lines
33 lines
34 control line
35 reservoir line
36 reservoir line
I reservoir
II reservoir
III reservoir
IV reservoir
AG trailer
AM trailer modulator
ASY trailer brake system
BK1 brake circuit
BK2 brake circuit
BK3 brake circuit
BK4 brake circuit
BZA trailer service brake cylinder
BZH rear axle service brake cylinder
BZV front axle service brake cylinder
CAN bus system
DS safety margin
ECM central unit
ECU electronic control device
EH electropneumatic control module
FBA trailer spring-loaded brake cylinder
FBZ spring-loaded brake cylinder
FSB spring-loaded brake
FSY parking brake system
H electric switch
KBZ combination brake cylinder
MV front axle modulator
P brake encoder
P1 pressure gradient
P2 pressure gradient
pA output pressure
pH spring-loaded accumulator holding pressure
pL spring-loaded accumulator release pressure
pV reservoir pressure
S1 point of intersection
S2 point of intersection
t1 point in time
t2 point in time
t3 point in time
TC trailer control module
VBO actuating member at the parking valve
VT valve
VTA valve output
VTE1 valve input
VTE2 valve input
ZG towing vehicle

1. A method for operating a parking brake system with a spring-loaded brake and a control module in a motor vehicle or trailer, wherein the control module is connected to a parking brake circuit, the method comprising:
supplying the parking brake circuit with reservoir pressure; and,
applying spring-loaded accumulator holding pressure to the spring-loaded brake cylinders in order to have the spring-loaded brake assume a release position, wherein the spring-loaded accumulator holding pressure is less than the reservoir pressure in the parking brake circuit.

2. The method of claim 1, wherein the spring-loaded accumulator holding pressure is 1 to 5 bar below the reservoir pressure.

3. The method of claim 1, wherein the spring-loaded accumulator holding pressure is 1.5 to 3 bar below the reservoir pressure.

4. The method of claim 1, wherein the spring-loaded accumulator holding pressure is above a spring-loaded accumulator release pressure by at least a safety margin.

5. The method of claim 4, wherein the safety margin is at least 1 to 2 bar.

6. The method of claim 1, wherein the spring-loaded accumulator holding pressure is determined by a valve assembly which acts in at least one of a pressure-limiting manner, a pressure-reducing manner, and a pressure-regulating manner.

7. The method of claim 1, wherein the spring-loaded accumulator holding pressure is set by computer program-controlled regulation of a valve assembly.

8. A parking brake system comprising:
a spring-loaded brake;
a control module for a motor vehicle or trailer;
said control module being connected to a brake circuit, wherein the brake circuit is supplied with a reservoir pressure;
said spring-loaded brake including spring-loaded brake cylinders configured to have a spring-loaded accumulator holding pressure applied thereto in order to assume a release position of said spring-loaded brake; and,
a setting device for setting the spring-loaded accumulator holding pressure to a value which is less than the reservoir pressure in the brake circuit.

9. The parking brake system of claim 8, wherein said setting device is a valve assembly having an input pressure and an output pressure, wherein said valve assembly is configured to supply the spring-loaded accumulator holding pressure as an output pressure.

10. The parking brake system of claim 9 further comprising an electronic control device configured to regulate the output pressure of said valve assembly.

11. The parking brake system of claim 10 further comprising a pressure sensor for sensing the output pressure and for transmission to said electronic control device.

12. The parking brake system of claim 10, wherein said valve assembly has a pneumatic relay valve and an electropneumatic proportional valve; the output pressure is present at an output of said valve assembly; said relay valve is configured to receive control pressure from said electropneumatic proportional valve; and, said proportional valve is configured to be activated by said electronic control device in order to set the output pressure.

13. The parking brake system of claim 10, wherein said valve assembly and said electronic control device are constituent parts of said control module.

14. The parking brake system of claim 9, wherein said valve assembly includes a pressure limiting valve.

15. The parking brake system of claim 14, wherein said valve assembly has a non-return valve connected in parallel to said pressure limiting valve.

16. The parking brake system of claim 9, wherein said valve assembly is integrated into said control module.

17. The parking brake system of claim 9, wherein said valve assembly is integrated into a pneumatic control line between a parking valve assembly and said control module.

18. The parking brake system of claim 9, wherein said valve assembly is integrated into a parking valve assembly which is connected to said control module via a pneumatic control line.

19. The parking brake system of claim 9, wherein said valve assembly is integrated into a brake cylinder assembly.

20. The parking brake system of claim 9, wherein said valve assembly is integrated into pneumatic working lines between said control module and said spring-loaded brake cylinders.

21. The parking brake system of claim 8, wherein said control module is an axle modulator.

22. A computer program product which comprises commands which, carried out on an electronic control device of a control module in a parking brake system, carry out the method of claim 7.

23. An electropneumatic control module comprising an electronic control device and configured for use in the parking brake system of claim 8.

24. A vehicle comprising the parking brake system of claim 8.
